(19) United States
(12) Patent Application Publication
(10) Pub. No.: US 2002/0049268 A1
(43) Pub. Date: Apr. 25, 2002

(54) Flame retardant molding compositions having improved flow

(76) Inventors: Roger J. White, South Strabane, PA (US); Robert A. Pyles, Bethel Park, PA (US)

Correspondence Address: BAYER CORPORATION, PATENT DEPARTMENT, 100 BAYER ROAD, PITTSBURGH, PA, 15205, US

(21) Appl. No.: 09/939,551

(22) Filed: Aug. 27, 2001

Related U.S. Application Data
(63) Continuation of application No. 08/569,274, filed on Dec. 8, 1995.

(51) Int. Cl. C08K 5/52

(52) U.S. Cl. 524/127

(57) ABSTRACT

Thermoplastic molding compositions containing a polycarbonate resin and a phosphorous containing compound characterized in their improved melt flow are disclosed. Accordingly, the spiral flow and melt flow index of the resin is greatly enhanced upon the incorporation of an additive amount of a phosphorous containing compound conforming to

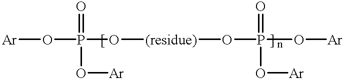

where -(residue)-, n and Ar are defined. An embodiment characterized by its flame retardance is also disclosed.

This application is a Continuation-In-Part of application Ser. No. 08/335,428 filed Nov. 7, 1994.

### FIELD OF THE INVENTION

The invention concerns thermoplastic molding compositions and, in particular, compositions containing polycarbonate and a phosphorous containing compound.

### SUMMARY OF THE INVENTION

Thermoplastic molding compositions containing a polycarbonate resin and a phosphorous containing compound characterized in their improved melt flow are disclosed. Accordingly, the spiral flow and melt flow index of the resin is greatly enhanced upon the incorporation of an additive amount of a phosphorous containing compound conforming to

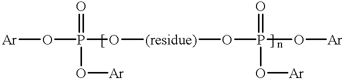

where -(residue)-, n and Ar are defined. An embodiment characterized by its flame retardance is also disclosed.

### BACKGROUND OF THE INVENTION

Phosphorous containing compounds have long been recognized for their efficacy as flame retarding agents and thermal stabilizers in thermoplastic molding compositions, including polycarbonate molding compositions. Patents relating to this technology include U.S. Pat. No. 4,111,899 which disclosed compounds having P to P bonds as thermal and oxygen stabilizers of thermoplastic resins. The flame retarding efficacy of triaryl phosphates in the context of a polymeric resin was disclosed in U.S. Pat. No. 4,526,917; the utility of other phosphorous containing compounds as flame retardant agents for polymers was disclosed in U.S. Pat. No. 5,130,452. Flame retardant thermoplastic compositions containing a mixture of carbonate polymer, a styrene copolymer and/or a graft rubber polymer, polytetraflouroroethylene and a phosphorous containing compound were disclosed in U.S. Pat. Nos. 4,751,260, 4,914,144 and 5,234,979. Also relevant is U.S. Pat. No. 5,204,394 which disclosed a flame retardant blend containing an oligomeric phosphate. A plasticized composition containing a polycarbonate resin and tetra(lower alkaryl)p-phenylene diphosphate was disclosed in U.S. Pat. No. 5,122,556.

### DETAILED DESCRIPTION OF THE INVENTION

Spiral flow in the context of the composition is a well recognized term of art. A description of spiral flow molding may be found in Injection Molding Theory and Practice, A Wiley-Interscience Publication, John Wiley & Sons by Irvin I. Rubin, PP. 232-233; also in “Spiral Flow Molding”, by L. Griffith in Modern Plastics, August, 1957. The spiral flow measurements in the course of the work leading up to the present invention were made by using a variable thickness spiral flow tool (set at 0.100″) in a 3 oz. molding machine. Molding conditions were as follows:

| | |
|---|---|
| Primary Pressure | 18,000 psi |
| Secondary Pressure | 10,000 psi |
| Back Pressure | 800 psi |
| Screw Speed | 100 rpm |
| Injection Speed | 4 inches/second |
| Cushion | 0.250″ |
| Mold Temperature | 155° F. |
| Melt Temperature | 490° F. |

Melt flow rate in the present context is determined in accordance with ASTM D-1238 at 250° C. with a 5 kg. load.

The invention resides in the enhanced spiral flow and/or melt flow rate of the composition. The composition of the invention exhibits a considerable improvement, at least about 16% in terms of spiral flow over that of the unmodified resin; alternatively, the improvement in terms of melt flow index is about 60% over the unmodified resin.

The thermoplastic composition of the invention contains (i) polycarbonate resin and (ii) an additive amount preferably about 5 to 30 percent by weight of a phosphorous containing compound conforming to

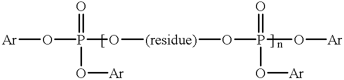

where n is about 1 to 7, preferably about 1 to 3, Ar is an aryl group, preferably a phenyl group and -(residue)- denotes the residue of a specific dihydroxydiaryl or a diglycol from which the hydrogen atoms of the OH groups have been removed. Among the suitable dihydroxydiaryl compounds are the ones conforming to formulae (I) and (II)

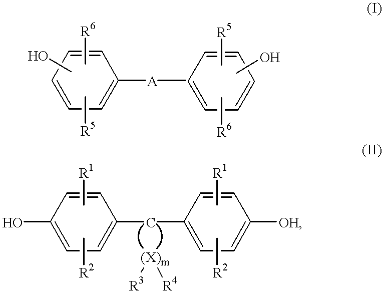

wherein

A is a single bond, C₁-C₅-alkylene, C₂-C₅-alkylidene, C₅-C₆-cycloalkylidene, —O—, —S— or —SO₂—,

R⁵ and R⁶ independently of one another represent hydrogen methyl or halogen, in particular methyl, chlorine or bromine,

R¹ and R² independently of one another represent hydrogen, halogen, preferably chlorine or bromine, C₁-C₈-alkyl, preferably methyl or ethyl, C₅-C₆-cycloalkyl, preferably cyclohexyl, C₆-C₁₀-aryl, preferably phenyl, or C₇-C₁₂-aralkyl, preferably phenyl-C₁-C₄-alkyl, in particular benzyl,

m is an integer from 4 to 7, preferably 4 or 5,

R³ and R⁴ can be individually selected for each X and independently of one another denote hydrogen or C₁-C₆-alkyl and

X denotes carbon.

The diglycol suitable in the invention has 1 to 30 carbon atoms, preferably 2 to 15 carbon atoms.

Especially suitable phosphorous containing compounds are bisphenol-A bisdiphenylphosphate which conform to

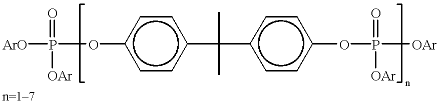

and neopentyl glycol bis(diphenyl phosphate) conforming to

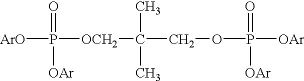

wherein Ar is as defined above.

The amount of phosphorous containing compound added to the polycarbonate resin is that amount which imparts to the composition an improved degree of spiral flow and melt flow. More preferably, the amount added is about 1 to 15 percent, more preferably, about 5 to 15 percent of the phosphorous containing compound relative to the weight of the polycarbonate composition.

Aromatic polycarbonates within the scope of the present invention are homopolycarbonates and copolycarbonates and mixtures thereof.

The polycarbonates generally have a weight average molecular weight of 10,000-200,000, preferably 20,000-80,000 and their melt flow rate, per ASTM D-1238 at 300° C., is about 1 to about 65 g/10 min., preferably about 2-15 g/10 min. They may be prepared, for example, by the known diphasic interface process from a carbonic acid derivative such as phosgene and dihydroxy compounds by polycondensation (see German Offenlegungsschriften 2,063,050; 2,063,052; 1,570,703; 2,211,956; 2,211,957 and 2,248,817; French Patent 1,561,518; and the monograph H. Schnell, “Chemistry and Physics of Polycarbonates”, Interscience Publishers, New York, N.Y., 1964, all incorporated herein by reference).

In the present context, dihydroxy compounds suitable for the preparation of the polycarbonates of the inventor conform to the structural formulae (1) or (2).

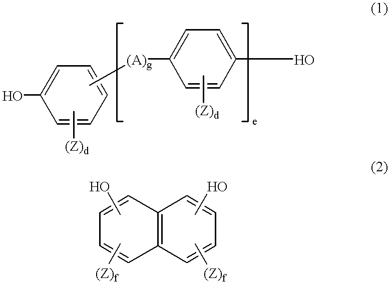

wherein

A denotes an alkylene group with 1 to 8 carbon atoms, an alkylidene group with 2 to 8 carbon atoms, a cycloalkylene group with 5 to 15 carbon atoms, a cycloalkylidene group with 5 to 15 carbon atoms, a carbonyl group, an oxygen atom, a sulfur atom, —SO— or —SO₂— or a radical conforming to

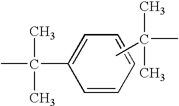

e and g both denote the number 0 to 1; Z denotes F, Cl, Br or C₁-C₄-alkyl and if several Z radicals are substituents in one aryl radical, they may be identical or different from one another; d denotes an integer of from 0 to 4; and f denotes an integer of from 0 to 3.

Among the dihydroxy compounds useful in the practice of the invention are hydroquinone, resorcinol, bis-(hydroxyphenyl)-alkanes, bis-(hydroxyphenyl)-ethers, bis-(hydroxyphenyl)-ketones, bis-(hydroxyphenyl)-sulfoxides, bis-(hyd roxyphenyl)-sulfides, bis-(hyd roxyphenyl)-sulfones, and α,α-bis-(hydroxyphenyl)-diisopropylbenzenes, as well as their nuclear-alkylated compounds. These and further suitable aromatic dihydroxy compounds are described, for example, in U.S. Pat. Nos. 3,028,356; 2,999,835; 3,148,172; 2,991,273; 3,271,367; and 2,999,846, all incorporated herein by reference.

Further examples of suitable bisphenols are 2,2-bis-(4-hydroxyphenyl)-propane (bisphenol A), 2,4-bis-(4-hydroxyphenyl)-2-methylbutane, 1,1-bis-(4-hydroxyphenyl)-cyclohexane, α,α′-bis-(4-hydroxyphenyl)-p-diisopropylbenzene, 2,2-bis-(3-methyl-4-hydroxyphenyl)-propane, 2,2-bis-(3-chloro-4-hydroxyphenyl)-propane, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl)-sulfide, bis-(3,5-dimethyl-4-hydroxyphenyl)-sulfoxide, bis-(3,5-dimethyl-4-hydroxyphenyl)-sulfone, dihydroxy-benzophenone, 2,4-bis-(3,5-dimethyl-4-hydroxyphenyl)-cyclohexane, α,α′-bis-(3,5-dimethyl-4-hydroxyphenyl)-p-diisopropylbenzene and 4,4′-sulfonyl diphenol.

Examples of particularly preferred aromatic bisphenols are 2,2,-bis-(4-hydroxyphenyl)-propane, 2,2-bis-(3,5-dimethyl-4-hydroxyphenyl)-propane and 1,1-bis-(4-hydroxyphenyl)-cyclohexane.

The most preferred bisphenol is 2,2-bis-(4-hydroxyphenyl)-propane (bisphenol A).

The polycarbonates of the invention may entail in their structure units derived from one or more of the suitable bisphenols.

Among the resins suitable in the practice of the invention are included phenolphthalein-based polycarbonate, copolycarbonates and terpolycarbonates such as are described in U.S. Pat. Nos. 3,036,036 and 4,210,741, both incorporated by reference herein.

The polycarbonates of the invention may also be branched by condensing therein small quantities, e.g., 0.05-2.0 mol % (relative to the bisphenols) of polyhydroxyl compounds.

Polycarbonates of this type have been described, for example, in German Offenlegungsschriften 1,570,533; 2,116,974 and 2,113,374; British Patents 885,442 and 1,079,821 and U.S. Pat. No. 3,544,514. The following are some examples of polyhydroxyl compounds which may be used for this purpose: phloroglucinol; 4,6-dimethyl-2,4,6-tri-(4-hydroxyphenyl)-heptane; 1,3,5-tri-(4-hydroxyphenyl)-benzene; 1,1,1-tri-(4-hydroxyphenyl)-ethane; tri-(4-hydroxyphenyl)-phenylmethane; 2,2-bis-[4,4-(4,4′-dihydroxydiphenyl)]-cyclohexyl-propane; 2,4-bis-(4-hydroxy-1-isopropylidine)-phenol; 2,6-bis-(2′-dihydroxy-5′-methylbenzyl)-4-methylphenol; 2,4-dihydroxybenzoic acid; 2-(4-hydroxyphenyl)-2-(2,4-dihydroxyphenyl)-propane and 1,4-bis-(4,4′-dihydroxytriphenylmethyl)-benzene. Some of the other polyfunctional compounds are 2,4-dihydroxybenzoic acid, trimesic acid, cyanuric chloride and 3,3-bis-(4-hydroxyphenyl)2-oxo-2,3-dihydroindole.

In addition to the polycondensation process mentioned above, other processes for the preparation of the polycarbonates of the invention are polycondensation in a homogeneous phase and transesterification. The suitable processes are disclosed in the incorporated herein by references, U.S. Pat. Nos. 3,028,365; 2,999,846; 3,153,008; and 2,991,273.

The preferred process for the preparation of polycarbonates is the interfacial polycondensation process.

Other methods of synthesis in forming the polycarbonates of the invention such as disclosed in U.S. Pat. No. 3,912,688, incorporated herein by reference, may be used.

Suitable polycarbonate resins are available in commerce, for instance, Makrolon FCR, Makrolon 2600, Makrolon 2800 and Makrolon 3100, all of which are bisphenol based homopolycarbonate resins differing in terms of their respective molecular weights and characterized in that their melt flow indices (MFR) per ASTM D-1238 are about 16.5-24, 13-16, 7.5-13.0 and 3.5-6.5 g/10 min., respectively. These are products of Bayer Corporation, of Pittsburgh, Pa.

A polycarbonate resin suitable in the practice of the invention is known and its structure and methods of preparation have been disclosed, for example in U.S. Pat. Nos. 3,030,331; 3,169,121; 3,395,119; 3,729,447; 4,255,556; 4,260,731; 4,369,303 and 4,714,746 all of which are incorporated by reference herein.

The composition of the invention may include any of the conventional additives fillers and reinforcing agents. These mineral fillers, plasticizers, fluidizing agents, stabilizers against UV light, heat, moisture and the action of oxygen, pigments and flame retardants may be incorporated in the composition in art-recognized amounts by following conventional procedures.

In a preferred embodiment, the composition further contains (iii) about 0 to 30 percent of a graft rubber copolymer (iv) about 0 to 30 percent of an aromatic vinyl copolymer and (v) about 0 to 5 percent polytetraflouroethylene (PTFE). In further preferred embodiments, the composition contains about 3 to 15 percent graft rubber copolymer, 7 to 20 percent aromatic vinyl copolymer, 5 to 30 percent phosphorous containing compound and 35 to 85 percent polycarbonate resin.

The graft rubber copolymer useful in the preferred embodiments of the invention is an ABS type polymer, the molecules of which contains two or more polymeric parts of different compositions, namely a rubber base (substrate) and a graft part (the grafted phase), that are bonded chemically. These are prepared by polymerizing a suitable monomer, for instance, butadiene or a conjugated diene, optionally with a comonomer polymerizable therewith such as styrene, to yield the rubber base. After the formation of the rubber base at least one grafting monomer, typically two, are polymerized (grafted phase) in the presence of the rubber base to obtain the graft rubber copolymer. The graft rubber copolymers which are preferably prepared by the known emulsion graft polymerization process are typically obtained by grafting at least one of the following monomers: chloroprene, butadiene-1,3, isoprene, 1,3-heptadiene, methyl-1,3-pentadiene, 2,3-dimethylbutadiene, 2-ethyl-1,3-pentadiene, 1,3- and 2,4-hexadiene as well as chloro and bromo-substituted butadienes, ethylene, propylene, vinyl acetate and C₁₋₁₈ (meth)acrylate esters. Among the more preferred graft bases, mention may be made of butadiene, and butadiene/styrene. Other suitable monomers are described in “Methoden Der Organischen Chemie” (Houben-Weyl), Bd. 14/1, Georg Thieme-Verlag, Stuttgart 1961, pp.393-406 and in C. B. Bucknall, “Toughened Plastics”, Appl.Science Publishers, London 1977, the disclosures of which are incorporated herein by reference.

The grafted phase may include styrene and/or acrylonitrile and/or alkyl (meth)acrylate, vinyl acetate, acrylonitrile and/or styrene.

Preferred graft copolymers are partially crosslinked and have gel content above 20 percent, preferably above 60 percent, relative to their weight. These grafts may be obtained by polymerization of 5-90, preferably 30 to 80, parts by weight (pbw) of a mixture of 50-95 pbw of at least one member selected from the group consisting of substituted or unsubstituted styrene, alpha-methyl styrene and methyl methacrylate and 5 to 50 pbw of at least one member selected from the group consisting of acrylonitrile methacrylonitrile, methyl methacrylate, maleic anhydride and maleimide, in the presence of 10-95, preferably 20 to 70, pbw rubber having a glass transition temperature under −10° C., as a graft base.

Especially preferred graft copolymers are ABS grafts.

In the preparation of the graft copolymer, the rubber substrate conjugated diolefin polymer or copolymer exemplified by a 1,3-butadiene polymer or copolymer preferably is present at a level of from 15 to 90 percent by weight, and more preferably at from 30 to 70 percent by weight, and most preferably about 50 percent by weight, of the total ABS graft polymer. The monomers polymerized in the presence of the substrate to form the grafted portion, exemplified by styrene and acrylonitrile, preferably are together present at a combined level of from about 10 to about 85 percent by weight of the total ABS graft polymer, more preferably 30 to 70 weight percent thereof and most preferably about 50 weight percent thereof. It is additionally preferred that the second group of grafting monomers, exemplified by acrylonitrile ethyl acrylate and methyl methacrylate, comprise from about 10 percent to about 40 percent by weight of the grafted portion of the ABS resin while the monovinylaromatic hydrocarbon monomers, exemplified by styrene, comprise from about 60 to about 90 percent by weight of the grafted portion of the ABS resin.

Suitable graft copolymers have been disclosed in U.S. Pat. Nos. 3,931,356; 3,957,912; 3,991,136; 4,206,293; 4,277,574; 4,559,386; 4,598,124; 5,075,375 and 3,130,177, the disclosures of which are incorporated herein by reference.

The aromatic vinyl copolymer suitable in the present context is the polymerization product of at least one, and preferably two monovinyl aromatic hydrocarbons. The preferred monovinyl aromatic monomers utilized are generically described by the formula:

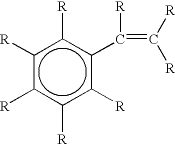

wherein R is selected from the group consisting of hydrogen, alkyl groups containing from 1 to 5 carbon atoms, cycloalkyl, aryl, alkaryl, aralkyl, alkoxy, aryloxy chloro and bromo. Examples of the monovinyl aromatic compounds and substituted monovinyl aromatic compounds that may be used are styrene and other vinyl-substituted aromatic compounds including alkyl-, cyclo-, aryl-, alkaryl-, alkoxy-, aralkyl-, aryloxy-, and other substituted vinyl aromatic compounds. Examples of such compounds are 3-methylstyrene; 3,5-diethylstyrene and 4-n-propylstyrene, α-methylstyrene, α-methylvinyl-toluene, α-chlorostyrene, vinyltoluene, α-bromostyrene, chlorophenyl ethylene, dibromophenyl ethylene, tetrachlorophenyl ethylene, 1-vinyl-naphthalene, 2-vinyinaphthalene, mixtures thereof and the like. The preferred monovinyl aromatic hydrocarbon used herein is styrene and/or a-methylstyrene.

The second group of monomers polymerized in the preparation of the copolymer of the invention conform to

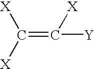

wherein X is hydrogen, C₁₋₅ alkyl, chlorine or bromine and Y is selected from the group consisting of cyano and carbalkoxy groups where the alkoxy group contains 1 to 12 carbon atoms. Examples include acrylonitrile, substituted acrylonitrile, ethacrylonitrile, methacrylonitrile, α-chloroacrylonitrile, β-chloroacrylonitrile, α-bromoacrylonitrile and β-bromoacrylonitrile, and/or acrylic acid esters such as methacrylate, methylmethacrylate, ethylacrylate, butylacrylate, propylacrylate, isopropylacrylate, isobutylacrylate, mixtures thereof and the like. The preferred acrylic monomer used herein is acrylonitrile and the preferred acrylic acid esters are ethylacrylate and methylmethacrylate. Typically the copolymer contains about 50 to 95 pbw of the monomer(s) of the first group and about 5 to 50 pbw of monomer(s) of the second group. The preferred copolymer is styrene acrylonitrile (SAN) a resin which is well known and available in commerce.

The tetrafluoroethylene polymers suitable in the present context are polymers having a fluorine content of about 65 to 76% by weight, preferably 7 to 76%. Examples are polytetrafluoroethylene, tetrafluoroethylene/hexafluoropropylene copolymers and tetrafluoroethylene copolymers with small amounts of chlorine-free copolymerizable ethyleneically unsaturated monomers.

These polymers as well as the methods for their preparation are known—see in this connection U.S. Pat. Nos. 2,393,697 and 2,534,058; the disclosures of which are incorporated herein by reference. Suitable polytetrafluoroethylene are available in commerce, for instance, as Hostaflon TF 2026 from Hoechst.

The preparation of the compositions of the invention follows conventional procedures which are well known in the art.

The invention is further illustrated but is not intended to be limited by the following examples in which all parts and percentages are by weight unless otherwise specified.

### EXAMPLES

Experimental:

Compositions within the scope of the present invention have been prepared and their properties determined as summarized below. In preparing these compositions and the comparative compositions the following materials were used:

POLYCARBONATE: Makrolon 2600—a homopolycarbonate based on bisphenol-A, having a melt flow rate of 11 g/10 min. per ASTM D-1238; (300° C., 1.2 kg. load).

COPOLYMER: styrene-acrylonitrile having a weight ratio of S/AN of about 72/28.

ABS: acrylonitrile-butadiene-styrene graft polymer, having a polybutadiene content of about 50 weight and a weight ratio of styrene/acrylonitrile of 72/28.

PTFE: polytetrafluoroethylene was added to the composition as a concentrate of 10% PTFE in ABS. The ABS used in the preparation of the concentrate was characterized in that it contained 55% by weight polybutadiene and the remainder (45%) contained SAN in a weight ratio of styrene/acrylonitrile of 72/28. The amount of ABS noted in the table includes the ABS derived from the concentrate.

The phosphate compound in composition A: resorcinol diphenyl phosphate conforming to

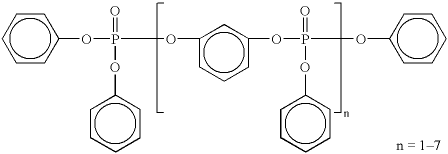

in composition C: neopentyl glycol bis(diphenyl phosphate) conforming to

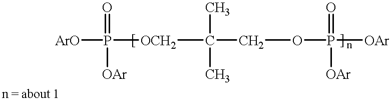

in composition B: bisphenol A(diphenylphosphate) conforming to

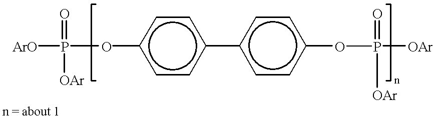

in composition D: resorcinol dixylylphosphate conforming to

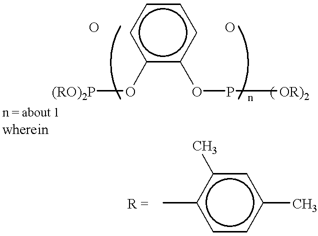

The amounts of the components were adjusted so as to obtain a substantially identical phosphorous content in the compositions.

TABLE 1

| Ingredient | A | B | C | D |
|---|---|---|---|---|
| Polycarbonate | 68.4 | 66.9 | 66.1 | 66.9 |
| copolymer | 10.2 | 10.0 | 9.9 | 10.0 |
| ABS | 7.7 | 7.5 | 7.4 | 7.5 |
| phosphate | 10.2 | 12.3 | 13.2 | 12.3 |
| PTFE | 3.6 | 3.4 | 3.4 | 3.4 |
| approximate P % | 1.10 | 1.10 | 1.18 | 1.10 |
| in formulation | | | | |
| Melt Flow Rate¹ | 20.8 | 40.5 | 39.7 | 32.7 |
| (g/10 mm) | | | | |
| Spiral Flow², inches | 25.25 | 32 | 32 | 29 |
| Tensile Strength, | 8.7 | 9.0 | 8.8 | 9.4 |
| Yield (kpsi) | | | | |
| Elongation at Yield (%) | 3.0 | 3.2 | 2.4 | 2.4 |
| Tensile Strength, | 8.6 | 6.9 | 7.6 | 7.5 |
| @ Break (kpsi) | | | | |
| Elongation at Break (%) | 118.0 | 63.0 | 122.0 | 95.8 |
| Flexural Strength (kpsi) | 15.7 | 15.7 | 15.1 | 16.1 |
| Flexural Modulus | 4.2 | 4.2 | 4.2 | 4.3 |
| (psi × 10⁵) | | | | |
| Vicat, VST B/120° C. | 97.6 | 92.3 | 84.7 | 94.3 |
| Notched Izod Impact | 13.7 | 12.2 | 13.1 | 10.2 |
| .125 in. 73F (ft*lbs) | | | | |
| Instrumented Impact 23° C., | | | | |
| 125 mu, Total Energy | 41.8 | 39.4 | 38.0 | 39.7 |
| (ft*lbs) | | | | |
| Flammability, UL 94 5V | 5V | 5V | Fail | Fail |
| 125 mu sv | | | | |
| Melt Stability | | | | |
| @ 5 min | 636 | 345 | 409 | 382 |
| @ 35 min | 654 | 364 | 345 | 318 |
| @ 65 min 654 | 364 | 345 | 318 | |
| Melt Viscosity (Pa*s) at: | | | | |
| 8.5 | 1,218 | 582 | 945 | 709 |
| 17.0 | 1,000 | 518 | 700 | 682 |
| 42.6 | 764 | 400 | 491 | 436 |
| 85.1 | 636 | 345 | 409 | 382 |
| 170.2 | 573 | 327 | 373 | 350 |
| 425.5 | 407 | 244 | 273 | 256 |
| 851.0 | 298 | 196 | 205 | 204 |
| 1702 | 209 | 147 | 149 | 152 |

¹@250° C. and 5000 g load
²100 mil @ 490° F.

The results demonstrate the higher melt flow rate and improved spiral flow, which characterize compositions B and C which represent the invention.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A thermoplastic molding composition having an improved spiral flow comprising
(i) polycarbonate resin and
(ii) about 5 to 30 percent relative to the weight of said composition of a phosphorous containing compound conforming to 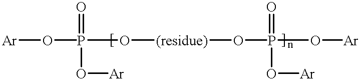
where
n is about 1 to 7,
Ar is an aryl group, and
-(residue)- denotes a dihydroxydiaryl or a C₁₋₃₀ diglycol from which the OH groups have been removed, wherein said dihydroxydiaryl is selected from the group consisting of formulae (I) and (II) 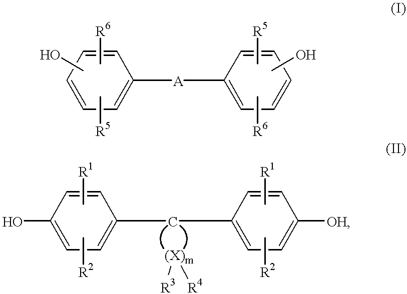
wherein
A is a single bond, C₁-C₅-alkylene, C₂-C₅-alkylidene, C₅-C₆-cycloalkylidene, —O—, —S— or —SO₂—,
R⁵ and R⁶ independently of one another represent hydrogen methyl or halogen,
R¹ and R² independently of one another represent hydrogen, halogen, C₁-C₈-alkyl, C₅-C₆-cycloalkyl, C₆-C₁₀-aryl, or C₇-C₁₂-aralkyl,
m is an integer from 4 to 7, and where
R³ and R⁴ are individually selected for each X and independently denote hydrogen or C₁-C₆-alkyl and
X denotes carbon,
and improved spiral flow beind in comparison to the spiral flow of the unmodified resin.

2. The composition of claim I further containing (iii) about 0-30% by weight of graft rubber copolymer (iv) about 0-30% by weight of a vinyl aromatic copolymer and (v) about 0-5% by weight polytetrafluoroethylene.

3. The composition of claim 2 wherein said graft rubber copolymer is the polymerization product of 5-90 pbw of a mixture of 50-95 pbw of at least one member selected from the group consisting of substituted or unsubstituted styrene, α-methyl styrene and methyl methacrylate and 5 to 50 pbw of at least one member selected from the group consisting of acrylonitrile methacrylonitrile, methyl methacrylate, maleic anhydride and maleimide, in the presence of 10-95 pbw rubber having a glass transition temperature under −10° C., as a graft base.

4. The composition of claim 3 wherein said graft base is selected from the group consisting of chioroprene, butadiene-1,3-isoprene, 1,3-heptadiene, methyl-1,3-pentadiene, 2,3-dimethylbutadiene, 2-ethyl-1,3-pentadiene, 1,3-hexadiene and 2,4-hexadiene.

5. The composition of claim 2 wherein said aromatic vinyl copolymer is the polymerization product of (a) at least one member selected from the group consisting of styrene 3-methyl-styrene; 3,5-diethylstyrene, 4-n-propylstyrene, α-methylstyrene, α-methylvinyltoluene, α-chlorostyrene, vinyltoluene, α-bromostyrene, chlorophenyl ethylene, dibromophenyl ethylene, tetrachlorophenyl ethylene, 1-vinylnaphthalene, 2-vinyinaphthalene, and (b) at least one member selected from the group consisting of acrylonitrile, substituted acrylonitrile, ethacrylonitrile, methacrylonitrile, α-chloroacrylonitrile, β-chloroacrylonitrile, α-bromoacrylonitrile, β-bromoacrylonitrile, and acrylic acid ester.

6. The composition of claim 5 wherein said (a) is at least one member selected from the group consisting of styrene and α-methylstyrene.

7. The composition of claim 2 wherein said copolymer is styrene acrylonitrile resin.

8. The composition of claim 2 wherein said graft rubber copolymer is ABS and said aromatic vinyl copolymer is SAN.

9. The composition of claim 2 wherein said graft rubber copolymer is present in an amount of 3-15%, said aromatic vinyl copolymer is present in amount of 7-20%, said phosphorus compound is present in amount of 5-30% and said polycarbonate is present in an amount of 35-85%.
